(19) United States
(12) Patent Application Publication
(10) Pub. No.: US 2013/0253989 A1
(43) Pub. Date: Sep. 26, 2013

(54) USING THE INHERITANCE OF PROFESSIONAL-SOCIAL NETWORK INFORMATION TO FACILITATE ORGANIZATIONAL POSITION CHANGES

(71) Applicants: CHIRAG K. BARHATE, PUNE (IN); MAHESH S. PARADKAR, PUNE (IN)

(72) Inventors: CHIRAG K. BARHATE, PUNE (IN); MAHESH S. PARADKAR, PUNE (IN)

(73) Assignee: INTERNATIONAL BUSINESS MACHINES CORPORATION, ARMONK, NY (US)

(21) Appl. No.: 13/425,608

(22) Filed: Mar. 21, 2012

(51) Int. Cl. G06Q 10/06

(52) U.S. Cl. 705/7.36; 705/348

(57) ABSTRACT

A method for maintaining professional-social networks can begin with the automatic creation of a professional-social network for each member of an organization by a professional-social network tool based upon electronic communication analysis. Each member can have a uniquely-identified organizational position within an organizational model of the organization. A professional-social network can be comprised of nodes representing the member's contacts that can be connected to the member by relationships that express an interaction context. In response to a change from a currently-held first organizational position to a second organizational position for a specified member, the specified member can be dissociated from the professional-social network of the first organizational position. The specified member can then be associated with the professional-social network of the second organizational position. Tacit information contained within the professional-social network for performing the job functions of the second organizational position can be inherited by the specified member.

### BACKGROUND

The present invention relates to the field of data handling and, more particularly, to using the inheritance of professional-social network information to facilitate organizational position changes.

A common problem in many organizations is the documentation and/or loss of tacit information that members naturally accrue as they perform the job functions of their organizational position. Tacit information are those subtle data nuggets that members learn over time like who is the best supplier to order from or what font your supervisor prefers for documents.

When members leave the organization, this tacit information is often lost. The replacing member is left having to re-accrue this knowledgebase, which takes time and often results in a period of reduce productivity and/or efficiency. To address such problems, a variety of knowledge management tool have been developed. However, these conventional knowledge management tools still rely heavily upon a member entering the tacit information into the defined fields. In addition to being a single point of failure, this reliance requires that a member be aware of the tacit information that they are accruing and be able to express the information clearly for future use.

Further, conventional knowledge management tools often lack a direct relationship to the job functions defined for a specific member and/or that member's organizational position. Thus, the member is required to take the time to assess the applicability of each data item to their specific job function and/or organizational position.

For example, many knowledge management tools allow data items to be assigned to a category like “Lessons Learned”. Without additional granularity, a member must take the time to read through the data items of the category to determine applicability.

To mitigate this problem, conventional knowledge management tools allow keywords or tags to be assigned to data items. However, the use of keywords or tags often exacerbates the problem by introducing differences in the terms used as keywords or tags.

### BRIEF SUMMARY

One aspect of the present invention can include a method for maintaining professional-social networks. Such a method can begin with the automatic creation of a professional-social network for each member of an organization by a professional-social network tool based upon electronic communication analysis. Each member can have a uniquely-identified organizational position within an organizational model of the organization. A professional-social network can be comprised of nodes representing contacts with whom a member interacts with to perform job functions defined for their organizational position. The nodes can be connected to the member by relationships that express an interaction context. A contact can represent a person, a group of people, or another organization. In response to a change from a first organizational position to a second organizational position for a specified member, the specified member can be dissociated from the professional-social network of the first organizational position. The first organizational position can represent the organizational position currently held by the specified member and the second organizational position can represent the organizational position that the specified member is being moved into. The specified member can then be associated with the professional-social network of the second organizational position. Tacit information contained within the professional-social network for performing the job functions of the second organizational position can be inherited by the specified member.

Another aspect of the present invention can include a system for maintaining professional-social networks. Such a system can include organizational data, an organizational model, contacts, an electronic communications system, and professional-social network tool. The organizational data can define data items for the members of an organization. The organizational model can define uniquely-identified organizational positions having defined job functions held by the members of the organization. The contacts can represent a person, a group of people, or another organization with whom a member interacts with to perform the job functions defined for their organizational position. A contact can be a member of the organization or a non-member of the organization. The electronic communications system can be configured to convey electronic communications between the members and the contacts. The professional-social network tool can be configured to automatically create and maintain a professional-social network for each member based upon an analysis of the electronic communications in which the member is included. A professional-social network can be comprised of nodes representing the member's contacts that are connected to the member by relationships that express an interaction context. Tacit information about the performance of job functions of the member's organizational position can be captured within the professional-social network.

Yet another aspect of the present invention can include a computer program product that includes a computer readable storage medium having embedded computer usable program code. The computer usable program code can be configured to automatically create a professional-social network for each member of an organization based upon electronic communication analysis. Each member can have a uniquely-identified organizational position within an organizational model of the organization. A professional-social network can be comprised of nodes representing contacts with whom a member interacts with to perform job functions defined for their organizational position. The nodes can be connected to the member by relationships that express an interaction context. A contact can represent a person, a group of people, or another organization. The computer usable program code can be configured to, in response to a change from a first organizational position to a second organizational position for a specified member, dissociate the specified member from the professional-social network of the first organizational position. The first organizational position can represent the organizational position currently held by the specified member and the second organizational position can represent the organizational position that the specified member is being moved into. The computer usable program code can be configured to associate the specified member with the professional-social network of the second organizational position. Tacit information contained within the professional-social network for performing the job functions of the second organizational position can be inherited by the specified member.

### BRIEF DESCRIPTION OF THE SEVERAL VIEWS OF THE DRAWINGS

FIG. 1 is a flowchart of a method presenting, at a high-level, the use of a professional-social network tool to facilitate the transfer of tacit professional-social network information between members of an organization during a change in organizational position in accordance with embodiments of the inventive arrangements disclosed herein.

FIG. 2 is a schematic diagram illustrating a system that utilizes a professional-social network tool to facilitate the capture and transference of a professional-social network between members in accordance with an embodiment of the inventive arrangements disclosed herein.

FIG. 3 is a flowchart of a method discussing operation of the professional-social network tool in accordance with an embodiment of the inventive arrangements disclosed herein.

FIG. 4 is a flowchart of a method detailing the creation of professional-social networks by the professional-social network tool in accordance with embodiments of the inventive arrangements disclosed herein.

FIG. 5 is a collection of scenarios that graphically illustrate the inheritance of a professional-social network in accordance with embodiments of the inventive arrangements disclosed herein.

### DETAILED DESCRIPTION

The present invention discloses a solution for maintaining professional-social networks. A professional-social network tool can automatically create and maintain professional-social networks for members of an organization based upon the analysis of electronic communications exchanged between members for job-related purposes. Each member can have an organizational position having defined job functions that are captured in the organizational model of the organization. A professional-social network can be comprised of nodes that represent contacts that a member interacts with to perform the job functions defined for their organizational position. The nodes can be connected to the member by relationships that express an interaction context. As members change organizational positions, the tacit information contained in the professional-social networks can be preserved and inherited by other members of the organization.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

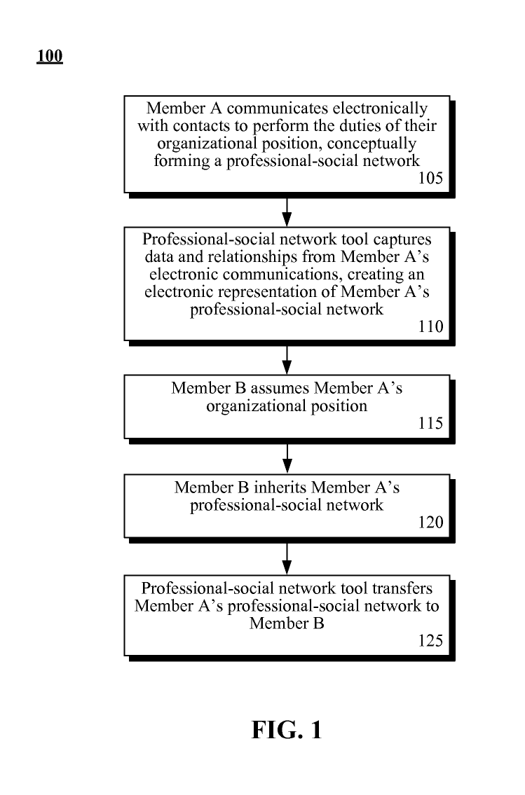

FIG. 1 is a flowchart of a method 100 presenting, at a high-level, the use of a professional-social network tool to facilitate the transfer of tacit professional-social network information between members of an organization during a change in organizational position in accordance with embodiments of the inventive arrangements disclosed herein.

Method 100 can begin in step 105 where Member A of an organization can electronically communicate with various contacts to perform the duties of their organizational position. As Member A performs step 105, a professional-social network for Member A's organizational position can be conceptually formed.

That is, the people or contacts that Member A interacts with in order to perform the duties of their job, which is directly controlled and/or represented by their position with the organization, can be abstractly thought of as a social network based in a professional context. Just as in a typical social network, Member A can have different types of relationships with the various contacts that comprise their professional-social network.

For example, Member A can be the receptionist of a doctor's office. To perform receptionist duties, Member A can be required to interact with the office staff, patients, accounts payable/receivable, insurance company representatives, and supply company representatives. These groups and individuals can comprise the professional-social network of Member A.

The electronic communications exchanged in step 105 can represent items, including, but not limited to, email messages, instant messages, social network postings, text messages, shared application messages and/or data, electronic documents, Web forms, and the like.

In step 110, the professional-social network tool can capture data and relationships from Member A's electronic communications. The professional-social network tool can be a software tool designed to create an electronic representation of any member's, Member A in this example, conceptual professional-social network. Step 110 can represent the capture of tacit organizational information that is accumulated by a person that performs the duties of a specific organization position.

The data captured in step 110 can correspond to the electronic communications exchanged in step 105. Further, data can be captured in its entirety, as a portion of a document or communication, and/or as a reference to a document or communication captured by another system (i.e., a reference to a specific email message belonging to Member A).

Continuing the previous example, while performing receptionist duties, Member A can build a rapport with specific contacts at each supplier and can come to understand which supplier is best used to order specific supplies. This knowledge can reside within Member A's memory and may not be formally documented for the organization.

Therefore, the loss of Member A from the doctor's office can result in the doctor's office losing this tacit information; Member A's replacement would need to re-learn all of this tacit information over time. Such situations can hinder the productivity and/or efficiency (e.g., loss of money by ordering from a less-than-optimal supplier, not knowing when to reorder supplies, etc.) of the doctor's office while the new receptionist rebuilds this knowledgebase.

Step 105 and 110 can be continuously performed to represent the continuous and dynamic growth and change of a member's professional-social network, such as changes in people representing a contact (i.e., Bob is now the representative for Supplier K) and/or contacts (i.e., Supplier M is now being used to purchase Product Y, instead of Supplier G).

As is inevitable in any organization, members change positions. In step 115, Member B can assume the organizational position of Member A. Member B can inherit the professional-social network of Member A in step 120.

The professional-social network tool can enable this inheritance by allowing the transference of Member A's professional-social network to Member B in step 125. Thus, as the new receptionist for the doctor's office, Member B can immediately know who to order which supplies from, when supplies should be ordered, and so on.

While many products exist for knowledgebase creation/maintenance, it is important to note that such conventional products can lack relational information between members and between the data and specific organizational positions. That is, conventional knowledgebase tools can group knowledge by topic or category without regard to its applicability to a perusing member's organizational position, requiring members to manually determine the applicability of each data item.

Some conventional knowledgebase tools can include the ability to add keywords or tags to data items. While such a capability increases the usability of these tools, this approach can require the member to know which keywords to use to refine data item searches. Regardless, conventional knowledgebase tools cannot provide a member with a listing of all the data items that pertain to how to perform the duties of their organizational position.

It is also important to note that conventional knowledgebase tools can be reliant upon member-entry of data; a member must document their tacit information. Such documentation can be difficult because a member may not realize the tacit information that they naturally collect or may simply forget to document the information. The professional-social network tool can automatically capture and/or determine tacit information about a member's organizational position, removing this reliance upon member documentation.

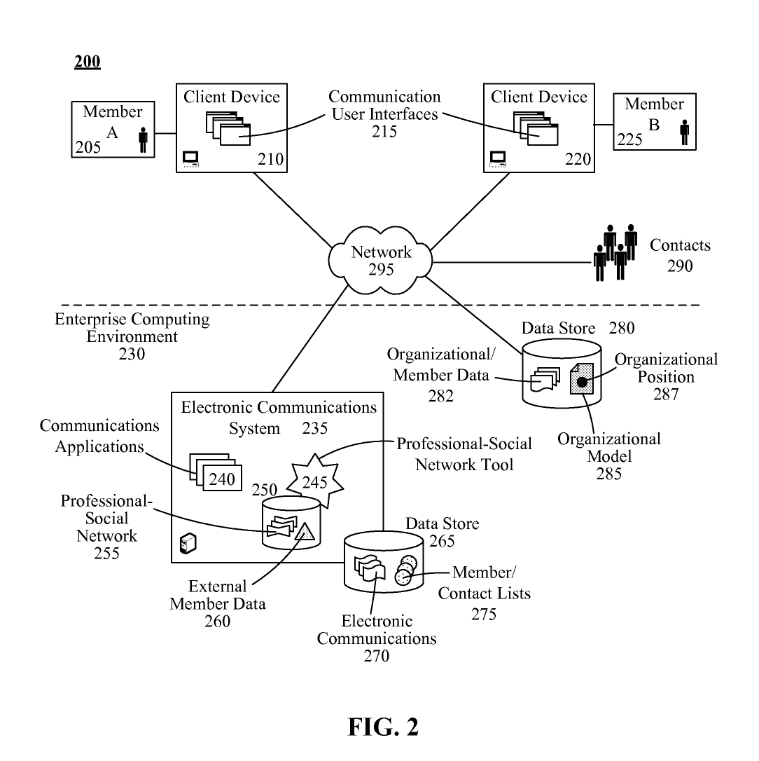

FIG. 2 is a schematic diagram illustrating a system 200 that utilizes a professional-social network tool 245 to facilitate the capture and transference of a professional-social network 255 between Members A and B 205 and 225 in accordance with embodiments of the inventive arrangements disclosed herein. System 200 can be utilized within the context of method 100.

In system 200, Member A 205 and Member B 225 can belong to the same organization. Members A and B 205 and 225 can be human agents of the organization. For illustrative purposes, Member B 225 can represent a person who assumes the organizational position held by Member A 205, as discussed in method 100.

Member A 205 can utilize the functions of an electronic communications system 235 to interact with one or more contacts 290. A contact 290 can represent a specific person or organization that Member A 205 interacts with to perform the duties of their organizational position 287. A contact 290 can be internal or external to Member A's 205 organization.

For example, if Member A 205 is a project manager, then each person involved with a project that Member A 205 is managing can be considered a contact 290 of Member A 205. As another example, if Member A 205 is an office manager, the office staff can be included in Member A's 205 contacts 290 as well as an office supply company, a cleaning service, and a temp agency.

The electronic communications system 235 can represent the hardware and/or software components required to support the exchange of electronic communications 270 over a network 295. The specific types of electronic communications 270 supported by the electronic communications system 235 can vary based upon organization and/or implementation of the electronic communications system 235.

The electronic communications system 235 can operate within an enterprise computing environment 230 maintained and/or accessible to the organization. The enterprise computing environment 230 can include additional software systems (not shown) without departing from the intent of the present disclosure.

The electronic communications system 235 can include one or more communications applications 240, the professional-social network tool 245, and a data store 265 containing electronic communications 270 and member/contact lists 275. An electronic communication 270 can be a discrete container of digital data like an email message.

The communications applications 240 can be the software programs that facilitate the exchange of electronic communications 270 over the network 295. Examples of communications applications 240 can include, but are not limited to, an email application, an instant messaging application, a Voice over Internet Protocol (VoIP) application (e.g., soft phone), a social network application, a text messaging system, an online collaboration system, a file download, a file upload, a Web service or application, a smart phone application, and the like.

As is common for many communications applications 240, Member A 205 can be provided with and/or allowed to create and maintain one or more member/contact lists 275. For example, a global email address list 275 can be maintained by the organization and can be utilized by Member A 205 when composing email messages; yet, Member A 205 can also be able to define their own email distribution lists 275.

Further, Member A 205 can have multiple member/contact lists 275, each corresponding to a different communications application 240. The member/contact lists 275 can also allow Member A 205 to categorize entries in their member/contact lists 275 (e.g., friends, coworkers, Project 1, Team J, etc.).

Members A and B 205 and 225 can access the functionality of the electronic communications system 235 provided by the communications applications 240 via a corresponding communication user interface 215. The communication user interface 215 can be a graphical means for creating and presenting the electronic communications 270 as well as viewing the contents of one's professional-social network 255.

The communication user interface 215 can be written to operate commensurately with the configuration of a client device 210 and 220 (i.e., an application written specifically for a smart phone) and/or the enterprise computing environment 230 (i.e., an application that conforms to SOA standards). The client device 210 and 220 can represent a variety of computing devices capable of supporting operation of the communication user interface 215 and communicating with the corresponding communications application 240 over the network 295.

The professional-social network tool 245 can be a software program designed to create professional-social networks 255 for an organizational position 287 based upon a member's 205 interaction with contacts 290. A professional-social network 255 can be a social network representation for a specific combination of member 205 and 225 and organizational position 287 in a professional or organizational context; a social network comprising only the people and/or other organizations that Member A 205 interacts with for professional or work-related purposes.

An organizational position 287 can be a job title held by a member 205 and/or 225 as defined in an organizational model 285 of the specific organization. The organizational model 285 can be a diagram that outlines the managerial relationships of an organization. More than one member 205 and 225 can have the same organizational position 287, yet different professional-social networks 255.

For example, Member A 205 and Member B 225 can both have the organizational position 287 of “Customer Representative”. However, Member A 205 can be responsible for West Coast customers and Member B 225 can be responsible for East Coast customers.

Each organizational position 287 can have a list of duties stored as organizational/member data 282. The organizational/member data 282 can also include historical data about a member 205 and 225 (e.g., promotion dates) and the organization (e.g., contract dates). The organizational/member data 282 and/or organizational model 285 can be maintained within a data store 280 that is accessible by the professional-social network tool 245.

In another embodiment, the contents of data store 280 can be maintained by multiple and/or disparate computing systems (not shown). In such an embodiment, the professional-social network tool 245 can be granted the appropriate security privileges and/or configured to interface with the computing systems in order to access the organizational/member data 282 and/or organizational model 285.

The professional-social network tool 245 can utilize the organizational/member data 282 and organizational model 285 to “understand” the basic structure of the organization and its members 205 and 225. By analyzing the electronic communications 270 exchanged between members 205 and 225 and contacts 290, the professional-social network tool 245 can create a professional-social network 255 for each member 205 and 225 and/or organizational position 287.

When a member's 205 or 225 contact 290 is external to the organization, the professional-social network tool 245 can capture basic data (e.g., name, organization, email address, etc.) about this contact 290 as external member data 260. Thus, the external member data 260 can act as a list of contacts 290 that are included in member's 205 and 225 professional-social networks 255 that are external to the organization.

Thus, as members 205 and 225 of the organization change organizational positions 287, the tacit knowledge for performing each organizational position 287 can be preserved and inherited by the incoming member 205 or 225.

For example, if Member A 205 retires and Member B 225 assumes Member A's 205 organizational position 287, the professional-social network tool 245 can allow Member B 225 to leave behind the professional-social network 255 they created for their old position and inherit the professional-social network 255 left by Member A 205. Now, Member B 225 can perform Member A's 205 old organizational position 287 with the knowledge that Member A 205 accrued during their tenure.

The professional-social network tool 245 can be comprised of a variety of sub-components representing its operations. The type of sub-components can vary based upon the specific implementation of and/or functionality provided by the professional-social network tool 245.

Examples of sub-components that can be used by the professional-social network tool 245 can include, but are not limited to, a social networking component, a natural language processor, a data aggregator, a graphical illustration component, a reports component, and the like.

In another contemplated embodiment, the professional-social network tool 245 can operate from a server (not shown) within the enterprise computing environment 230 that is separate from the electronic communications system 235. In such an embodiment, the professional-social network tool 245 can be configured to include the necessary elements (e.g., listener agents) required to monitor electronic communications 270 made using the electronic communications system 235 and interface with the electronic communications system 235 to access the electronic communications 270 and member/contact lists 275.

The transference of professional-social networks 255 between members 205 and 225 can be manually controlled by one or more administrators that have been given the proper permissions within the professional-social network tool 245 and/or can be automatically propagated by changes in the organizational/member data 282 and/or organizational model 285.

Additional contemplated functionality of the professional-social network tool 245 can include the ability for managers to view the professional-social networks 255 of their subordinates, the ability for members 205 and 225 to annotate the nodes of their professional-social networks 255, the ability to capture electronic communications 270 within the professional-social network 255 that was deleted by a member 205 or 225, and the ability to produce professional-social networks 255 of an organization at different levels of granularity (e.g., branch level, district level, head office level) and/or across different locations (i.e., all members of specific organizational position 287 throughout the organization).

Network 295 can include any hardware/software/and firmware necessary to convey data encoded within carrier waves. Data can be contained within analog or digital signals and conveyed though data or voice channels. Network 295 can include local components and data pathways necessary for communications to be exchanged among computing device components and between integrated device components and peripheral devices. Network 295 can also include network equipment, such as routers, data lines, hubs, and intermediary servers which together form a data network, such as the Internet. Network 295 can also include circuit-based communication components and mobile communication components, such as telephony switches, modems, cellular communication towers, and the like. Network 295 can include line based and/or wireless communication pathways.

As used herein, presented data stores 250, 265, and 280 can be a physical or virtual storage space configured to store digital information. Data stores 250, 265, and 280 can be physically implemented within any type of hardware including, but not limited to, a magnetic disk, an optical disk, a semiconductor memory, a digitally encoded plastic memory, a holographic memory, or any other recording medium. Data stores 250, 265, and 280 can be a stand-alone storage unit as well as a storage unit formed from a plurality of physical devices. Additionally, information can be stored within data stores 250, 265, and 280 in a variety of manners. For example, information can be stored within a database structure or can be stored within one or more files of a file storage system, where each file may or may not be indexed for information searching purposes. Further, data stores 250, 265, and/or 280 can utilize one or more encryption mechanisms to protect stored information from unauthorized access.

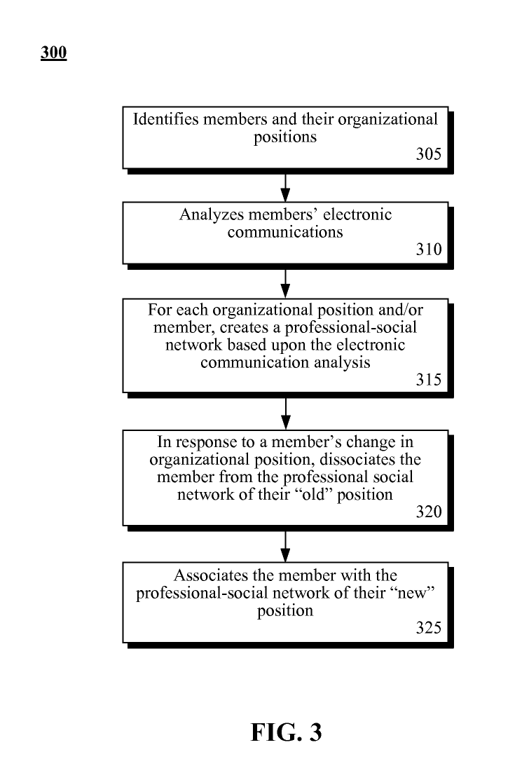

FIG. 3 is a flowchart of a method 300 discussing operation of the professional-social network tool in accordance with embodiments of the inventive arrangements disclosed herein. Method 300 can be performed within the context of system 200 and/or method 100.

Method 300 can begin in step 305 where the professional-social network tool can identify members of an organization and their organizational positions. Step 305 can require the professional-social network tool to access member/contact lists, organizational/member data, and the organizational model of the organization. The information required by the professional-social network tool can define the members of the organization, each member's organizational position, and the duties of each organizational position.

The electronic communications of the organization's members can be analyzed in step 310. Step 310 can utilize a variety of natural language processing techniques. In step 315, a professional-social network can be created for each organizational position and/or member based upon the analysis of the electronic communication analysis.

In response to a members change in organizational position, the professional-social network tool can dissociate the member from the professional-social network of their “old” organizational position in step 320. Then, in step 325, the member can be associated with the professional-social network of their “new” organizational position.

It should be noted that step 325 can be performed only when the member is moving to another organizational position. That is, only step 320 would be performed for a member who has left the organization.

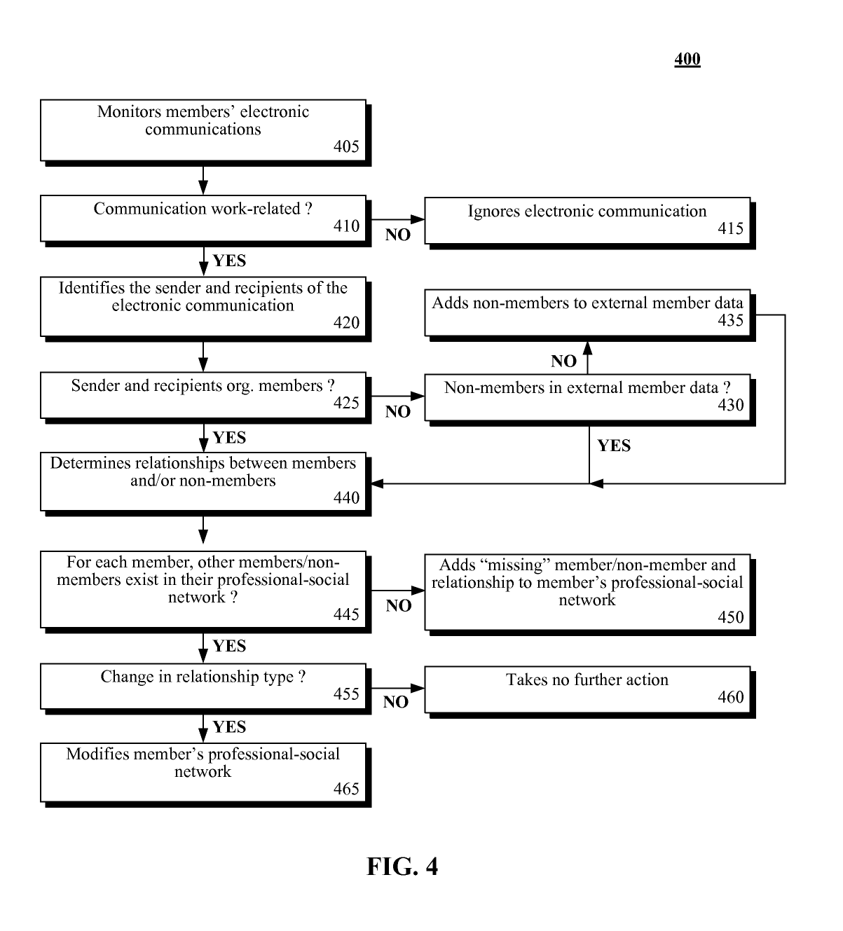

FIG. 4 is a flowchart of a method 400 detailing the creation of professional-social networks by the professional-social network tool in accordance with embodiments of the inventive arrangements disclosed herein. Method 400 can be performed within the context of system 200 and/or in conjunction with methods 100 and/or 300. Method 400 can be an elaboration of steps 310 and 315 of method 300.

Method 400 can begin in step 405 where the professional-social network tool can monitor the electronic communications of the organization's members. It can be determined if an electronic communication is work-related in step 410. Step 410 can ensure that social electronic communications are not included in a member's professional-social network.

When the electronic communication is not work-related, the electronic communication can be ignored in step 415. When the electronic communication is determined to be work-related, step 420 can be executed where the sender and recipients of the electronic communication can be identified.

It can be determined if the senders and recipients are all members of the organization in step 425. The determination performed in step 425 can reference the identified sender and recipients against organizational data that lists the organization's members.

When the sender or one or more recipients of the electronic communication are not members of the organization, step 430 can execute where the external member data can be checked to determine if these non-members are contained within. When a non-member does not exist within the external member data, the non-member can be added to the external member data in step 435.

Upon completion of step 435 or when the non-members already exist within the external member data, step 440 can execute where the relationship between members and/or non-members can be determined. Step 440 can utilize a variety of natural language processing techniques as well as relationship types and determination criteria predefined within the professional-social network tool.

For each member, it can be determined if the other members and/or non-members exist within their professional-social network in step 445. When one of the other members or non-members does not exist within a member's professional-social network, these “missing” members/non-members and their associated relationship with the member can be added to the professional-social network in step 450.

When all the other members and non-members exist within the member's professional-social network, step 455 can be performed where it can be determined if the type of relationship for the other members and non-members, as determined in step 440, are different than those already documented in the member's professional-social network. In order words, step 445 can determine if a change occurred to the organizational position of one of the other members or non-members that impacts their relationship to this member.

When a change in relationship type has occurred, the member's professional-social network can be modified to account for this change in relationship in step 465. When a change in relationship type has not occurred, then step 460 can execute where the professional-social network tool takes no further action with regards to the member's professional-social network.

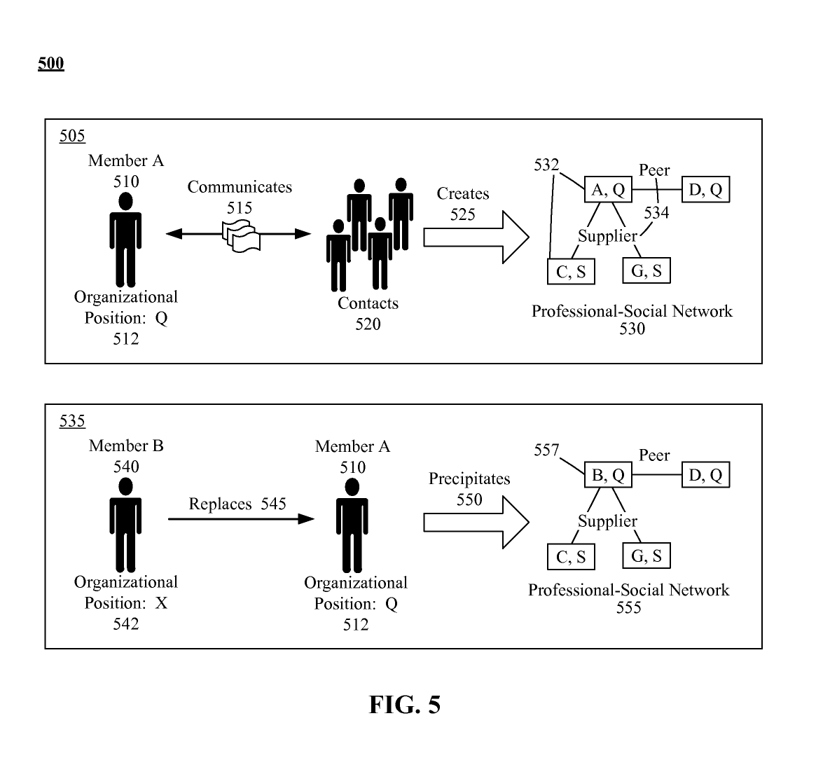

FIG. 5 is a collection 500 of scenarios 505 and 535 that graphically illustrate the inheritance of a professional-social network 555 in accordance with embodiments of the inventive arrangements disclosed herein. The scenarios 505 and 535 illustrated in collection 500 can be performed within the context of system 200 and represent one or more steps of methods 100, 300, and/or 400.

In scenario 505, Member A 510 can have an organizational position 512 of ‘Q’ within the organization. To fulfill the duties of organizational position 512 ‘Q’, Member A 510 can communicate 515 with various contacts 520. Based upon Member A's 510 communications with their contacts 520, the professional-social network tool can create 525 a professional-social network 530 specific to Member A 510 and their organizational position 512 ‘Q’.

As shown in scenario 505, the professional-social network 530 can be comprised of nodes 532 that represent Member A 510 and their contacts 520 arranged in a tree-like or relational structure. The nodes 532 of the professional-social network 530 can be connected by relationships 534. In this example, the professional-social network 530 for Member A 510 can indicate that Member A 510 has a “Peer” relationship 534 with Member D and a “Supplier” relationship 534 with Members C and G.

In scenario 535, Member B 540 having an organizational position 542 if ‘X’ can replace 545 Member A 510 within the organization. This action can cause Member B's 540 organizational position 542 to change from ‘X’ to ‘Q’.

The change in organizational position 542 for Member B 540 can precipitate 550 a corresponding change to Member B's 540 professional-social network 555. Since Member B 540 has left organizational position 542 ‘X’, the professional-social network that Member B 540 generated for organizational position 542 ‘X’ can be passed on to or inherited by their replacement. Member B 540 can then inherit the professional-social network 555 developed by Member A 510.

As shown in this example, using their “new” professional-social network 555, Member B 540 can know that Member D is their peer and Members C and D are suppliers to organizational position 512 ‘Q’.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-9. (canceled)

10. A computer implemented system for maintaining professional-social networks comprising:
one or more processors;
one or more memories storing program instructions executable on at least one of the one or more processors;
a plurality of organizational data defining a plurality of data items for a plurality of members of an organization;
an organizational model defining a plurality of uniquely-identified organizational positions held by the plurality of members of the organization, wherein each uniquely-identified organizational position has a plurality of job functions;
a plurality of contacts representing at least one of a person, a group of people, and another organization with whom a member interacts with to perform at least one job function defined for their organizational position, wherein a contact is at least one of a member of the organization and a non-member of the organization;
an electronic communications system, comprising at least one of the one or more processors and comprising at least one of the one or more memories, configured to convey a plurality of electronic communications between the plurality of members and the plurality of contacts; and
a professional-social network tool, comprising at least one of the one or more processors and comprising at least one of the one or more memories, configured to automatically create and maintain a professional-social network for each member based upon an automatic analysis of the plurality of electronic communications in which the member is included, wherein a professional-social network is comprised of nodes representing the member's contacts that are connected to the member by relationships that express an interaction context, wherein tacit information about a performance of the plurality of job functions of the member's organizational position is automatically captured within the professional-social network.

11. The system of claim 10, wherein the electronic communication comprises at least one of an email message, an instant message, a text message, a file upload, a file download, an audio communication, a video communication, an audio and video communication, an online collaboration system communication, a social network posting, and a blog posting.

12. The system of claim 10, wherein the professional-social network tool utilizes natural language processing techniques to perform the automatic analysis of the plurality of electronic communications.

13. The system of claim 10, further comprising:
a user interface configured to act as an interaction mechanism for performing at least one of a viewing of the professional-social network, a correction of data contained for a node of the professional-social network, and a presenting of reports.

14. The system of claim 13, wherein the user interface is further configured to allow members having a predefined minimum privilege level an ability to manually initiate a transference of the professional-social network containing tacit knowledge between members, wherein said transference overrides an existing organizational model structure, wherein the transference is capable of being assigned on at least one of a permanent and a temporary basis.

15. A computer program product comprising a non-transitory computer readable storage medium having computer usable program code embodied therewith, the computer usable program code comprising:
computer usable program code configured to automatically create a professional-social network for each member of an organization based upon electronic communication analysis, wherein each member has a uniquely-identified organizational position within an organizational model of the organization, wherein the professional-social network is comprised of nodes representing contacts with whom a member interacts with to perform job functions defined for the organizational position associated with the member, wherein said nodes are connected to the member by relationships that express an interaction context, and, wherein a contact represents at least one of a person, a group of people, and another organization;
computer usable program code configured to automatically convert tacit knowledge of a member of the organization into an electronic form based on an analysis of electronic communication of the member, wherein the tacit knowledge comprises information regarding job functions associated with the organizational position held by the member;
computer usable program code configured to associate the converted tacit knowledge of the member with the professional-social network of the organizational position held by the member;
computer usable program code configured to, in response to a change from a first organizational position to a second organizational position for a specified member, dissociate the specified member from the professional-social network of the first organizational position, wherein the first organizational position represents the organizational position currently held by the specified member and the second organizational position represents the organizational position that the specified member is being moved into; and
computer usable program code configured to associate the specified member with the professional-social network of the second organizational position, wherein tacit information contained within the professional-social network for performing the job functions of the second organizational position is inherited by the specified member.

16. The computer program product of claim 15, further comprising:
computer usable program code configured to, in response to a removal of the specified member from the organization, dissociating the specified member from the professional-social network of the first organizational position, wherein the first organizational position represents the organizational position currently held by the specified member, wherein the specified member is not assigned to the second organizational position.

17. The computer program product of claim 15, further comprising:
computer usable program code configured to, in response to an addition of the specified member to the organization, assign the first organizational position to the specified member; and
computer usable program code configured to associate the specified member with the professional-social network of the first organizational position, wherein tacit information contained within the professional-social network for performing the job functions of the first organizational position is inherited by the specified member.

18. The computer program product of claim 15, further comprising:
computer usable program code configured to, in response to one of a dissociation and an association of the professional-social network, record historical ownership data for the professional-social network, wherein said historical ownership data comprises at least an identifier associated with the specified member and a date when the one of the dissociation and the association occurred.

19. The computer program product of claim 15, wherein automatically creating the professional-social network further comprises:
computer usable program code configured to monitor a plurality of electronic communications exchanged between a member and their contacts;
computer usable program code configured to analyze the plurality of electronic communications to determine nodes and relationships applicable to the professional-social network of each member addressed by the electronic communication, wherein the professional-social network contains tacit knowledge of the each member; and
computer usable program code configured to, when necessary, modify the professional-social network of each member addressed by the electronic communication to reflect the nodes and relationships of said analysis.

20. The computer program product of claim 19, wherein analyzing of the plurality of electronic communications further comprises:
computer usable program code configured to determine a nature of an electronic communication, wherein said nature comprises at least one of professional and non-professional;
computer usable program code configured to, when the nature of the electronic communication is professional, identify members and non-members of the organization addressed as one of a sender and a recipient of the electronic communication based upon organizational data that defines current members of the organization, wherein non-members lack inclusion within said organizational data, and, wherein each identified member and non-member is considered as a node for potential inclusion within the members' professional-social networks;
computer usable program code configured to, for each identified member, ascertain a relationship between the member and each other node;
computer usable program code configured to compare the identified nodes and ascertained relationships to a current state of the member's professional-social network; and
computer usable program code configured to, when results of the comparison indicate differences, continue with the modification of the professional-social network for the member.

21. The computer program product of claim 20 further comprising:
computer usable program code configured to automatically remove the electronic communication from the analysis when the nature of the electronic communication is non-professional.

22. The computer program product of claim 19, wherein modifying the professional-social network further comprises:
computer usable program code configured to identify differences between a current state of the member's professional-social network and the nodes and relationships resulting from the analysis of the electronic communication;
computer usable program code configured to, for each difference, determine an inclusion importance of a difference based upon at least one of contextual indicators, organizational position, and the job functions of the organizational position; and
computer usable program code configured to, when the determined inclusion importance indicates an inclusion of the difference to the professional-social network, adjust the current state of the professional-social network to reflect the difference, wherein said adjustment comprises at least one of an addition of a node and relationship, a removal of the node and relationship, a change to secondary data associated with the node, a change to the relationship between the member and the node.

23. The computer program product of claim 22 further comprising:
computer usable program code configured to associate more than one members of the organization with the same organizational position but with different professional-social networks.

24. The method of claim 15 further comprising:
computer usable program code configured to determine a basic structure of the organization based on at least one of an organizational data, a member data, and an organizational model of the organization.

25. The method of claim 1 further comprising:
computer usable program code configured to automatically create a professional-social network for an organizational position based on analysis of communications exchanged between the members and the contacts.

26. A computer implemented system for maintaining and transferring tacit knowledge in an organization, the computer implemented system comprising:
one or more processors;
one or more memories storing program instructions executable on at least one of the one or more processors;
a professional-social network tool, comprising at least a subset of the program instructions, configured to:
enable a member of the organization to perform electronic communication with contacts of the member, wherein the member is associated with one of a plurality of uniquely identified organizational positions;
automatically convert tacit knowledge of the member of the organization into an electronic form based on an analysis of electronic communication of the member with the contacts, wherein the tacit knowledge comprises information regarding job functions associated with the organizational position held by the member;
store the converted tacit knowledge in the electronic form in a data store;
dissociate the member from the converted tacit knowledge stored in the data store when the member leaves the organizational position, wherein the converted tacit knowledge remains associated with the organization position; and
associate the converted tacit knowledge stored in the data store with a member entering the organizational position.

27. The computer implemented system of claim 26, wherein the professional-social network tool is further configured to:
automatically create a professional-social network for an organizational position based on analysis of communications exchanged between the members and the contacts.

28. The computer implemented system of claim 26, wherein the professional-social network tool is further configured to:
associate more than one members of the organization with the same organizational position but with different professional-social networks.

29. The computer implemented system of claim 26, wherein the professional-social network tool is further configured to:
determine a basic structure of the organization based on at least one of an data, a member data, and an organizational model of the organization.
